(19) United States
(12) Patent Application Publication
(10) Pub. No.: US 2009/0193925 A1
(43) Pub. Date: Aug. 6, 2009

(54) Three-Axis Displacement Platform

(76) Inventors: Pzung-Cheng LIOU, Taichung (TW); Chi-Pin Chou, Taichung (TW)

Correspondence Address: Dr. BANGER SHIA, 102 Lindencrest Ct., Sugar Land, TX, 77479-5201, US

(21) Appl. No.: 12/025,728

(22) Filed: Feb. 4, 2008

(51) Int. Cl. B66F 11/04

(52) U.S. Cl. 74/490.09

(57) ABSTRACT

A three-axis displacement platform comprises a first-axis linear device, a second-axis linear device, a third-axis linear device, a support frame and a balance weight. The three-axis displacement platform is formed by superposing the first-axis linear device, the second linear device, the support frame and the third-axis linear device on upon another, thus reducing the assembly space of the three-axis displacement platform. The balance weight is superposed on the support frame to balance weight, thus improving the displacement accuracy.

### BACKGROUND OF THE INVENTION

1. Field of the Invention

The present invention relates to a three-axis displacement platform, and more particularly to a three-axis displacement platform which utilizes a support frame to superpose linear modules on upon another.

2. Description of the Prior Art

With the rapid development of the automotive industry, machine tools have gradually substituted the manual labor. In order to improve the flexibility of the multi-axis machining, a three-axis (X-axis, Y axis and Z axis) displacement platform 90 has been developed on the market (as shown in FIG. 1). The three-axis displacement platform 90 comprises an X-axis linear module 91 for providing an X-axial displacement, a Y-axis linear module 92 for providing a Y-axial displacement, a support frame 93 and a Z-axis linear module 94 for providing a Z-axial displacement.

The X-axis linear module 91 is disposed on the Y-axis linear module 92, and the X-axis linear module 91 and the Y-axis linear module 92 transversely move. The support frame 93 is located beside the X-axis linear module 91 and the Y-axis linear module 92. The Z-axis linear module 94 is disposed at one side of the support frame 93, and one end of the Z-axis linear module 94 longitudinally moves with respect to the X-axis linear module 91 and the Y-axis linear module 92.

As known from a further analysis of the above structure, it has the following disadvantages:

Since the three-axis displacement platform 90 employs the Z-axis linear module 94, extra space is needed for locating the support frame 93, thus not only reducing the space utilization, but increasing the cost due to the erection of the support frame 93.

The present invention has arisen to mitigate and/or obviate the afore-described disadvantages.

### SUMMARY OF THE INVENTION

The primary objective of the present invention is to provide a three-axis displacement platform capable of reducing the three-axis space through the superposition assembly.

In order to achieve the above objective, the three-axis displacement platform in accordance with the present invention comprises a first-axis linear device, a second-axis linear device, a third-axis linear device, a support frame and a balance weight. The three-axis displacement platform is formed by superposing the first-axis linear device, the second linear device, the support frame and the third-axis linear device one upon another. The balance weight is superposed on the support frame. The second-axis linear device axially moves with the first-axis linear device. The support frame and the third-axis linear device axially move with the second-axis linear device, respectively. The direction in which the first-axis linear device axially moves intersects the direction in which the second-axis linear device axially moves. The direction in which the third-axis linear device axially moves intersects the direction in which the second-axis linear device axially moves.

As known from a further analysis of the above structure, it can obtain the following advantages:

1. The linear devices of the three-axis displacement platform in accordance with the present invention are superposed one upon another through the support frame, so that the support frame is directly located on the three-axis displacement platform without extra space for erection, thus not only reducing the assembly space, improving the flexibility of the space use, but improving the space utilization;

2. The three-axis displacement platform employs the balance weight on the support frame to balance the weight of the linear devices disposed on the support frame, so that the linear devices can balance weight through the balance weight during moving, thus improving the displacement accuracy of the linear slide rails.

### BRIEF DESCRIPTION OF THE DRAWINGS

FIG. 1 is a perspective view of a conventional three-axis displacement platform;

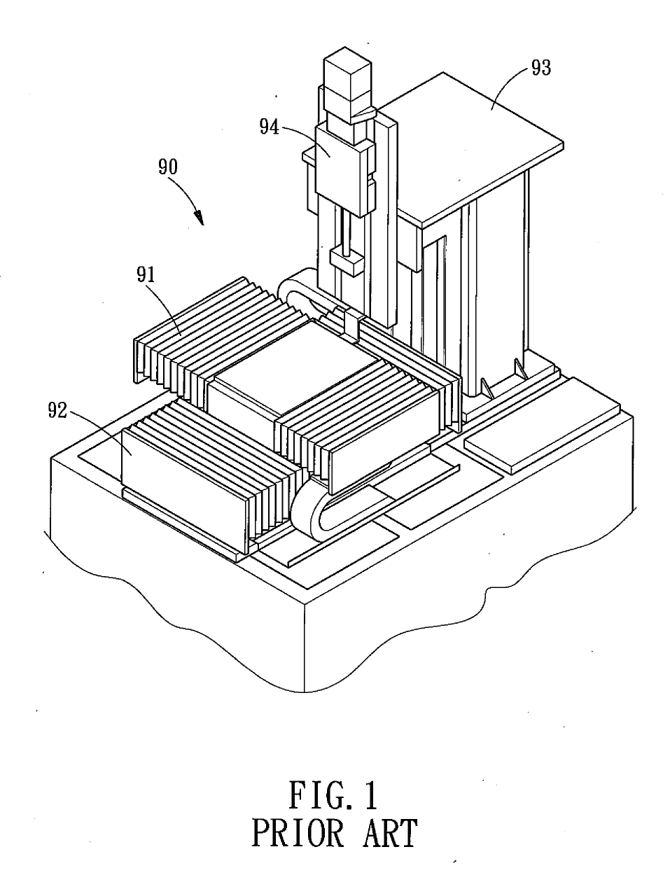

FIG. 2 is a first operational view of a three-axis displacement platform in accordance with the present invention;

FIG. 3 is a partial view of the three-axis displacement platform in accordance with the present invention;

FIG. 4 is a second operational view of the three-axis displacement platform in accordance with the present invention; and

FIG. 5 is a third operational view of the three-axis displacement platform in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

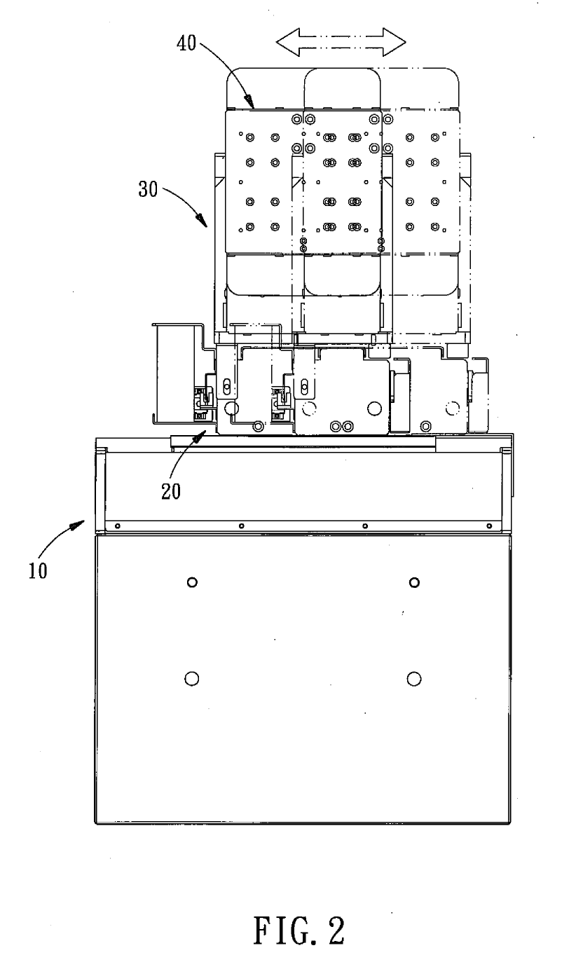

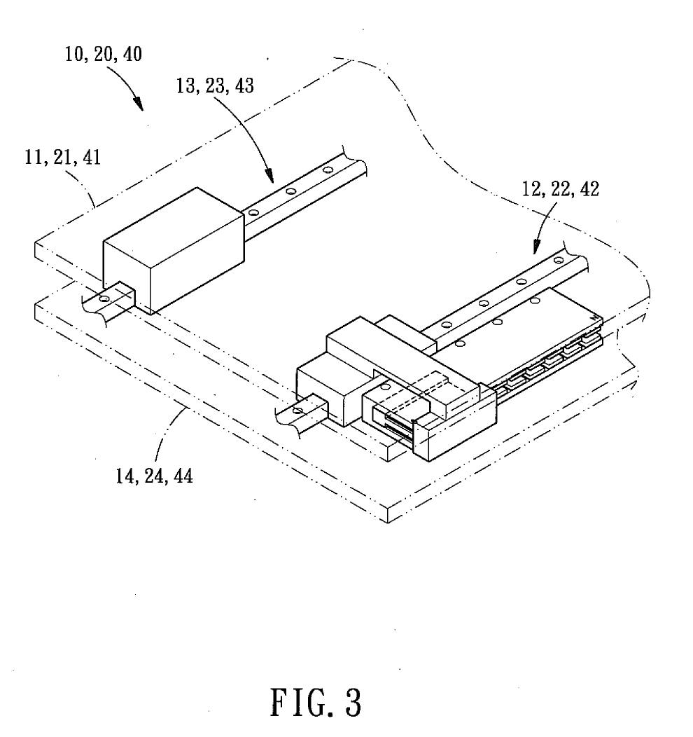

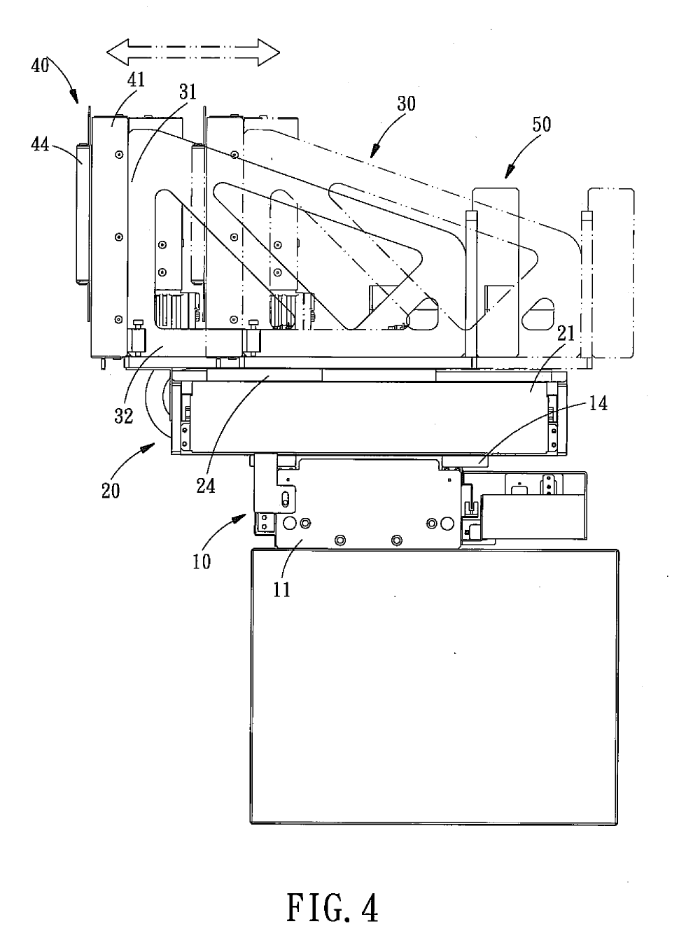

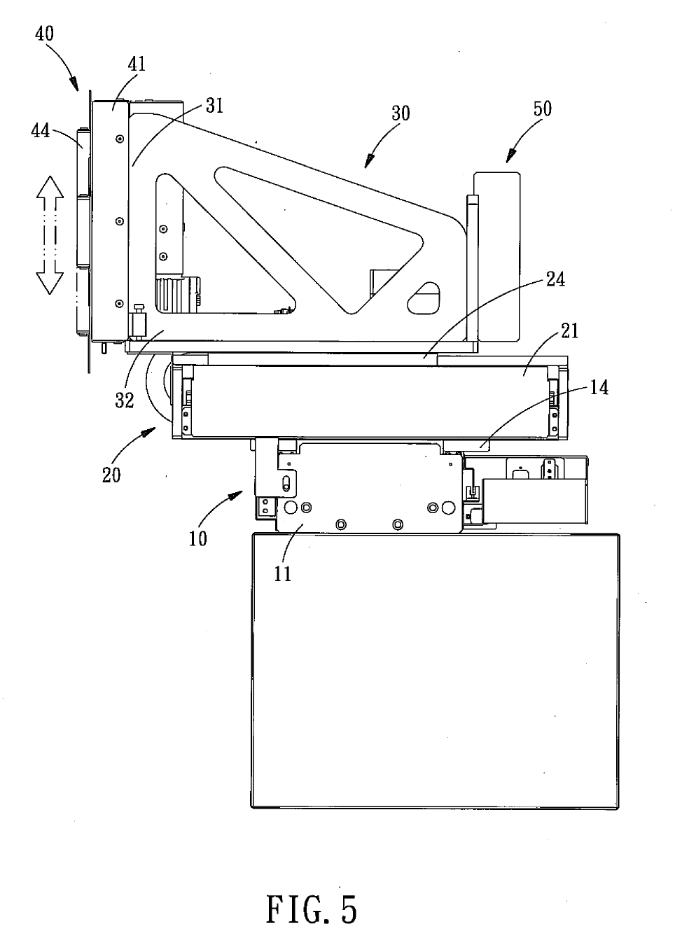

Referring to FIGS. 2-5, a three-axis displacement platform in according with the present invention comprises a first-axis linear device 10, a second-axis linear device 20, a support frame 30, a third-axis linear device 40 and a balance weight 50.

The first-axis linear device 10 includes a carrying seat 11, an active linear module 12, two passive linear modules 13 and a carrier 14.

The active module 12 and the passive modules 13 are disposed on the carrying seat 11.

The active linear module 12 includes a stator, a mover, a slide block and a slide seat. The stator is disposed with a plurality of side-by-side magnets. The mover is disposed with a plurality of connected windings. When the mover is supplied with the electric current to magnetically interact with the stator, the mover is enabled to move along the stator. The above stator and mover forms a linear motor. The slide block is slidably disposed on the slide seat, and the slide block and the mover are connected through a connecting member. When the mover moves with respect to the stator, the mover synchronously drives the slide block to slide on the slide seat.

The passive linear module 13 includes a slide block and a slide rail. The slide block is slidably disposed on the slide rail. One side of the carrying seat 11 is adjacently disposed with the active linear module 12 and the passive linear module 13, and the other side of the carrying seat 11 is disposed with the passive module 13. The two passive linear modules 13 are parallel and opposite each other.

The carrier 14 is disposed on the mover of the active linear module 12 and the slide block of the passive linear module 13. The carrier 14 moves in the X-axial direction with the active linear module 12. According to the operation requirements of the present linear device, it is necessary to employ one active linear module 12 and one passive linear module 13. The above arrangement can also be changed as desired.

The second-axis linear device 20 includes a carrying seat 21, an active linear module 22, two passive linear modules 23 and a carrier 24.

The active module 22 and the passive modules 23 are disposed on the carrying seat 21, and the carrying seat 21 is locked to the carrier 14 of the first-axis linear device 10 to move with it in the X-axial direction.

The active linear module 22 includes a stator, a mover, a slide block and a slide seat. The stator is disposed with a plurality of side-by-side magnets, and the mover is disposed with a plurality of connected windings. When the mover is supplied with the electric current to magnetically interact with the stator, the mover is enabled to move along the stator. The above stator and the mover form a linear motor. The slide block is slidably disposed on the slide seat. The slide block and the mover are connected through a connecting member. When the mover moves with respect to the stator, the mover synchronously drives the slide block to slide on the slide seat.

The passive linear module 23 includes a slide block and a slide rail. The slide block is slidably disposed on the slide rail. One side of the carrying seat 21 is adjacently disposed with the active linear module 22 and the passive linear module 23, the other side of the carrying seat 21 is disposed with the passive module 23. The above two passive linear modules 23 are parallel and opposite each other.

The carrier 24 is disposed on the mover of the active linear module 22 and the slide block of the passive linear module 23. The carrier 24 moves with the active linear module 22 in the Y-axial direction. According to the operation requirements of the present linear device, it is necessary to employ one active linear module 22 and one passive linear module 23. The above arrangement can also be changed as desired.

The moving direction of the second-axis linear device 20 after the active linear module 22 and the passive linear module 23 are installed intersects the moving direction of the first-axis linear device 10 after the active linear module 12 and the passive linear module 13 are assembled.

The support frame 30 is formed as an L-shaped structure, and it includes a first combining portion 31 and a second combining portion 32. One end of the first combining portion 31 is vertically connected to one end of the second combining portion 32. The support frame 30 is locked to the carrier 24 of the second-axis linear device 20 by the first combing portion 31 to move with it in the Y-axial direction.

The third-axis linear device 40 includes a carrying seat 41, an active linear module 42, two passive linear modules 43 and a carrier 44.

The active module 42 and the passive modules 43 are disposed on the carrying seat 41, and the carrying seat 41 is locked to the second combining portion 32 of the support frame 30 to move with it in the Y-axial direction.

The active linear module 42 includes a stator, a mover, a slide block and a slide seat. The stator is disposed with a plurality of side-by-side magnets, and the mover is disposed with a plurality of connected windings. When the mover is supplied with the electric current to magnetically interact with the stator, the mover is enabled to move along the stator. The above stator and the mover form a linear motor. The slide block is slidably disposed on the slide seat. The slide block and the mover are connected through a connecting member. When the mover moves with respect to the stator, the mover synchronously drives the slide block to slide on the slide seat.

The passive linear module 43 includes a slide block and a slide rail. The slide block is slidably disposed on the slide rail. One side of the carrying seat 41 is adjacently disposed with the active linear module 42 and the passive linear module 43, and the other side of the carrying seat 41 is disposed with the passive linear module 43. The above two passive linear module 43 are parallel and opposite each other.

The carrier 44 is disposed on the mover of the active linear module 42 and the slide block of the passive linear module 43. The carrier 44 moves with the active linear module 42 in the Z-axial direction. According to the operation requirements of the present linear device, it is necessary to employ one active linear module 42 and one passive linear module 43. The above arrangement can also be changed as desired.

The moving direction of the third-axis linear device 40 after the active linear module 42 and the passive linear module 43 are installed intersects the moving direction of the first-axis linear device 10 after the active linear module 12 and the passive linear module 13 are installed and the moving direction of the second-axis linear device 20 after the active linear module 22 and the passive linear module 23 are installed.

The weight of the balance weight 50 is set correspondingly to the weight of third-axis linear device 40. The balance weight 50 is vertically locked to the other end of the first combining portion 31 of the support frame 30, and the balance weight 50 is opposite the second combining portion 32 of the support frame 30.

To summarize, the present invention relates to a three-axis displacement platform which comprises a first-axis linear device, a second-axis linear device, a third-axis linear device, a support frame and a balance weight. The three-axis displacement platform is formed by superposing the first-axis linear device, the second-axis linear device, the support frame and the third-axis linear device one upon another, thus reducing the assembly space of the three-axis displacement platform. The balance weight is disposed on the support frame to balance the weight, thus improving the displacement accuracy.

While we have shown and described various embodiments in accordance with the present invention, it is clear to those skilled in the art that further embodiments may be made without departing from the scope of the present invention.

What is claimed is:

1. A three-axis displacement platform comprising:
a first-axis linear device for providing an X-axial displacement;
a second-axis linear device for providing a Y-axial displacement, the second-axis linear device being superposed on the first linear device to move with it to perform the X-axial displacement, a moving direction of the second-axis linear device intersecting a moving direction of the first-axis linear device;
a support frame, one side of the support frame being superposed on the second-axis linear device to move with it to perform the Y-axial displacement;
a third-axis linear device for providing a Z-axial displacement, the third-axis device being superposed on the other side of the support frame to move with it to perform the Y-axial displacement, a moving direction of the third-axis linear device intersecting the moving directions of the first-axis linear device and the second-axis linear device; and
a balance weight being disposed on the support frame for balancing weight.

2. The three-axis displacement platform as claimed in claim 1, wherein:
the first-axis linear device includes a carrying seat, an active linear module, two passive linear modules and a carrier, one side of the carrying seat of the first-axis device is adjacently disposed with the active linear module and the passive linear module of the first-axis linear device, and the other side of the carrying seat of the first-axis device is disposed with the passive linear module of the first-axis linear device, the carrier of the first-axis linear device is disposed on the passive linear module and the passive linear module of the first-axis device, the carrier of the first-axis linear device performs the X-axial displacement with the active linear module of the first-axis linear device;
the second-axis linear device includes a carrying seat, an active linear module, two passive linear modules and a carrier, the carrying seat of the second-axis linear device is disposed on the carrier of the first-axis device to move with it to perform the X-axial displacement, one side of the carrying seat of the second-axis device is adjacently disposed with the active linear module and the passive linear module of the second-axis linear device, and the other side of the carrying seat of the second-axis device is disposed with the passive linear module of the second-axis linear device, the carrier of the second-axis linear device is disposed on the active linear module and the passive linear module of the second-axis linear device, the carrier of the second-axis linear device performs the Y-axial displacement with the active linear module of the second-axis linear device; a moving direction of the second-axis device after the active linear module and the passive linear modules of the second-axis linear device are installed intersects a moving direction of the first-axis device after the active linear module and the passive linear modules of the first-axis linear device are installed;
the support frame includes a first combining portion and a second combining portion, one end of the first combining portion is vertically combined with one end of the second combining portion, the support frame is locked to the carrier of the second-axis linear device by the first combining portion to move with it to perform the Y-axial displacement;
the third-axis linear device includes a carrying seat, an active linear module, two passive linear modules and a carrier, the carrying seat of the third-axis linear device is locked to the second combining portion of the support frame to move with it to perform the Y-axial displacement, one side of the carrying seat of the third-axis device is adjacently disposed with the active linear module and the passive linear module of the third-axis linear device, and the other side of the carrying seat of the third-axis device is disposed with the passive linear module of the third-axis linear device, the carrier of the third-axis linear device is disposed on the active linear module and the passive linear module of the third-axis linear device, the carrier of the third-axis linear device performs the Z-axial displacement with the active linear module of the third-axis linear device; a moving direction of the third-axis device after the active linear module and the passive linear modules of the third-axis linear device are installed intersects the moving direction of the second-axis device after the active linear module and the passive linear module of the second-axis linear device are installed; and
the balance weight is vertically combined to the other end of the first combining portion of the support frame, the balance weight is opposite the second combining portion of the support frame.

3. The three-axis displacement platform as claimed in claim 1, wherein:
the first-axis linear device includes a carrying seat, an active linear module and a carrier, the active linear module of the first-axis linear device is disposed on the carrying seat of the first-axis linear device, the carrier of the first-axis linear device is disposed on the active linear module of the first-axis linear device, the carrier of the first-axis linear device performs the X-axial displacement with the active linear module of the first-axis linear device;
the second-axis linear device includes a carrying seat, an active linear module and a carrier, the carrying seat of the second-axis linear device is disposed on the carrier of the first-axis device to move with it to perform the X-axial displacement, the active linear module of the second-axis linear device is disposed on the carrying seat of the second-axis linear device, the carrier of the second-axis linear device is disposed on the active linear module of the second-axis module to move with it to perform the Y-axial displacement, a moving direction of the second linear device moves after the active linear module of the second linear device is installed intersects a moving direction of the first-axis linear device after the active linear module of the first-axis linear device is installed;
the support frame includes a first combining portion and a second combining portion, one end of the first combining portion is vertically combined with one end of the second combining portion, the support frame is locked to the carrier of the second-axis linear device by the first combining portion to move with it to perform the Y-axial displacement;
the third-axis linear device includes a carrying seat, an active linear module, and a carrier, the carrying seat of the third-axis linear device is locked to the second combining portion of the support frame to move with it to perform the Y-axial displacement, the active linear module of the third-axis linear device is disposed on the carrying seat of the third-axis linear device, the carrier of the third-axis linear device is disposed on the active linear module of the third-axis linear device, the carrier of the third-axis linear device performs the Z-axial displacement with the active linear module of the third-axis linear device, a moving direction of the third-axis linear device after the active linear module of the third-axis linear device is installed intersects the moving direction of the first-axis device after the active linear module of the first-axis device is installed and the moving direction of the second-axis linear device after the active linear module of the second-axis linear device; and
the balance weight is vertically combined to the other end of the first combining portion of the support frame, the balance weight is opposite the second combining portion of the support frame.
